(19) United States
(12) Patent Application Publication
(10) Pub. No.: US 2016/0015165 A1
(43) Pub. Date: Jan. 21, 2016

(54) Oral Hygiene Device

(71) Applicant: Peak Enterprises, Inc., Sarasota, FL (US)

(72) Inventors: Thomas A. Oechslin, Sarasota, FL (US); Gregory L. Rogers, Portage, OH (US)

(73) Assignee: Peak Enterprises, Inc., Sarasota, FL (US)

(21) Appl. No.: 14/799,027

(22) Filed: Jul. 14, 2015

Related U.S. Application Data
(60) Provisional application No. 62/025,201, filed on Jul. 16, 2014.

(51) Int. Cl. A46B 15/00; A61C 15/04; A46B 9/04; A61C 15/02

(52) U.S. Cl. CPC A46B 15/0069; A61C 15/02; A61C 15/046; A46B 9/04; A46B 15/0081

(57) ABSTRACT

An oral hygiene device that includes, among other things, a brush, a flosser, a pick and a tongue scraper.

### CROSS-REFERENCE TO RELATED APPLICATION

This relates to and claims the benefit of U.S. Provisional Patent Application No. 62/025,201, filed on Jul. 16, 2014, which is incorporated herein by reference in its entirety.

### TECHNICAL FIELD

This invention relates generally to dental devices. More specifically, the invention is directed to an oral hygiene device.

### BACKGROUND OF THE INVENTION

The cleaning of the tongue, teeth and gums is often done using separate dental devices. There is a need for a single device that can clean these areas.

### BRIEF SUMMARY OF THE INVENTION

An oral hygiene device that includes, among other things, a brush, a flosser, a pick and a tongue scraper.

### BRIEF DESCRIPTION OF THE DRAWINGS

FIG. 1 is a top plan view of an oral hygiene device according to the invention;

FIG. 2 is a right side elevational view thereof;

FIG. 3 is a bottom plan view thereof;

FIG. 4 is a left side elevational view thereof;

FIG. 5 is a first end elevational view thereof;

FIG. 6 is a second end elevational view thereof;

FIG. 7 is a cross-sectional view taken along line 7-7 as shown in FIG. 1;

FIG. 8 is a cross-sectional view taken along line 8-8 of FIG. 3; and

FIG. 9 is a right side elevational view thereof showing the handle being bent from a first position to a second position to expose the pick.

### DETAILED DESCRIPTION OF THE INVENTION

An oral hygiene device according to the invention will now be described in detail with reference being made to the drawings. An embodiment of the oral hygiene device is indicated generally in the drawings by the reference number “10.”

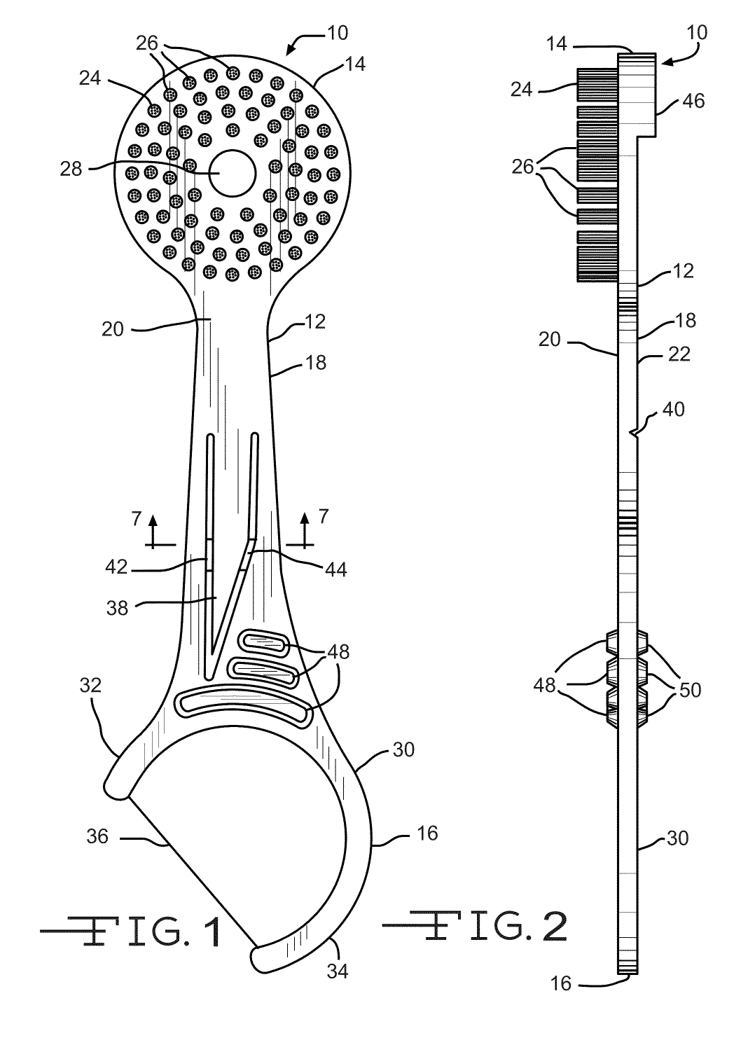

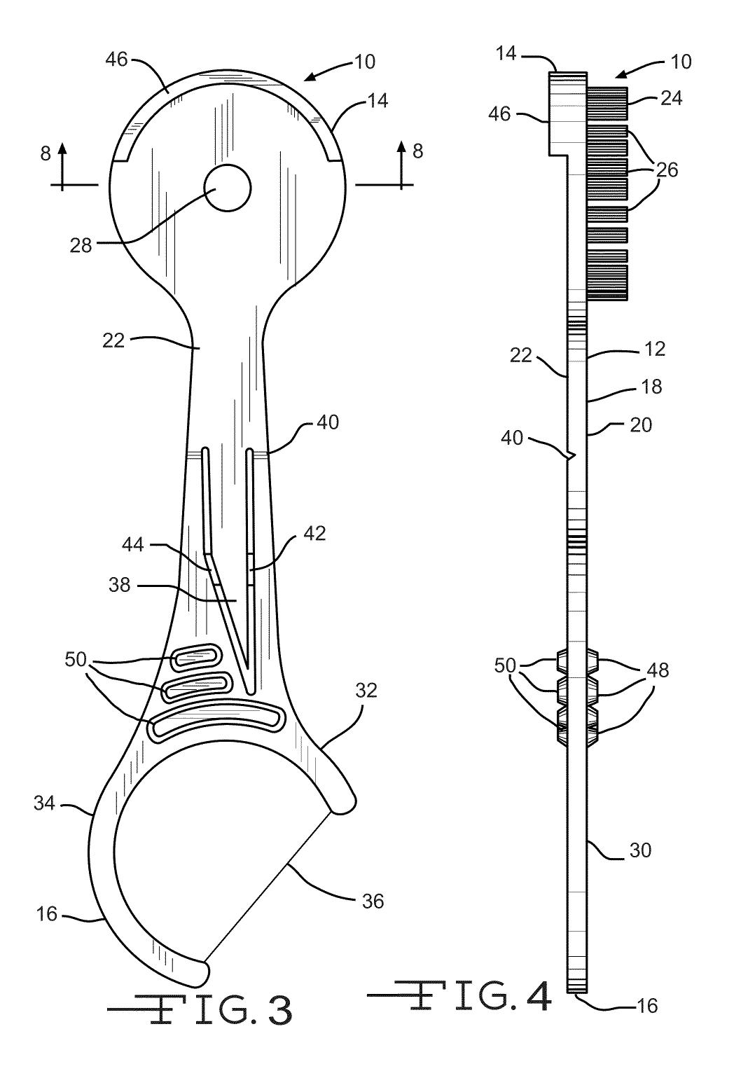

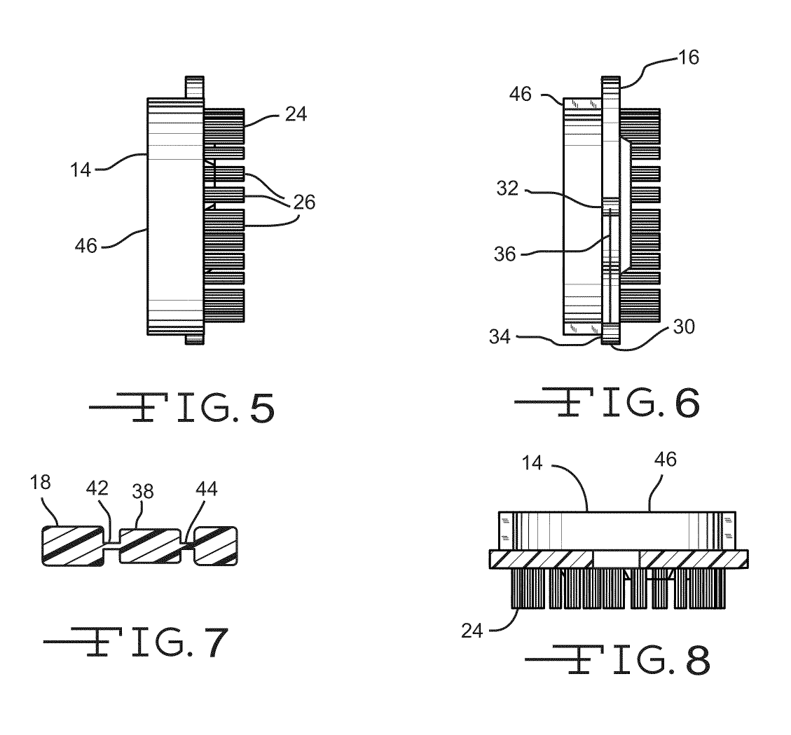

Referring to FIGS. 1-9, the device 10 has a body 12 including a first end 14, a second end 16, and a handle 18 extending between the first and second ends 14 and 16. The body 12 further includes a first side 20 and a second side 22. The first end 14 includes a brush 24 on the first side 20. In an embodiment, the first end 14 has a generally circular configuration and the brush 24 includes a plurality of bristles 26 that are arranged in such circular configuration. In an embodiment, the first end 14 includes an opening 28 that extends between the first and second sides 20 and 22, which is positioned in the center of such circular configuration.

As shown in FIGS. 1, 2 and 6, the second end 16 includes a flosser 30. In an embodiment, the flosser 30 includes a first support member 32 and a second support member 34 that are sized and adapted to support dental floss 36. In an embodiment, the second support member 34 is longer than the first support member 32.

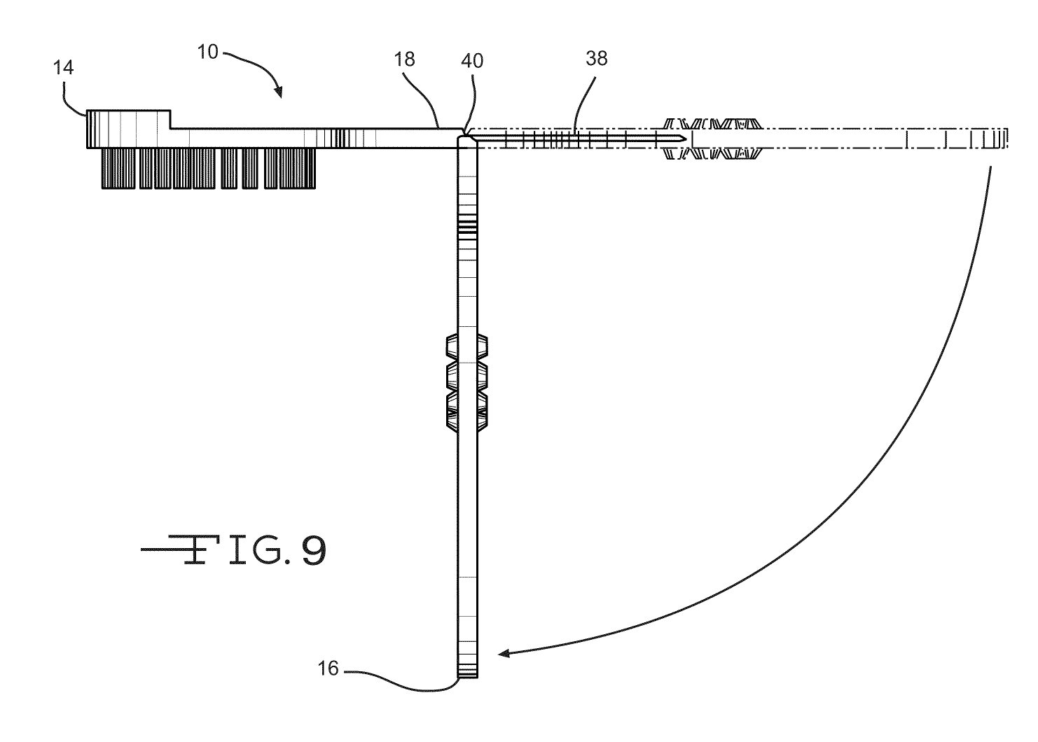

Referring to FIGS. 1-4, 7 and 9, the handle 18 includes a pick 38. As shown in FIGS. 2-4 and 9, the handle 18 includes a notch or hinge 40 that allows the second end 16 to be moved or bent from a first position to a second position to allow the pick 38 to be exposed for use. As shown in FIG. 9, the pick 38 extends outwardly from the first end 14. As shown in FIGS. 1, 3, 7 and 9, the pick 38 may be joined to the handle 18 by first and second attachment members 42 and 44, which are frangible to allow the second end 16 to be moved from the first position to the second position.

Referring to FIGS. 2-6 and 8, the device 10 may include a tongue scraper 46 positioned on the second side 22 at the first end 14. In an embodiment, the tongue scraper 46 has a generally semi-circular configuration, which corresponds to the generally circular shape of the first end 14.

Referring to FIGS. 1-4, the handle 18 may include one or more first side grips 48 and one or more second side grips 50 positioned adjacent to the second end 16. In an embodiment, the first and second side grips 48 and 50 are curved and have varying lengths.

The device 10 may be constructed of a variety of materials depending on use. In an embodiment, the device 10 is constructed of plastic. In an embodiment, the device 10 is disposable after use.

The oral hygiene device 10 provides a compact device that includes, among other things, a brush 24, a flosser 30, a pick 38 and a tongue scraper 46 for cleaning the tongue, teeth and gums. As it will be appreciated, this eliminates the need for separate devices.

While the invention has been described with reference to particular embodiments, it should be understood that various changes may be made and equivalents may be substituted for elements thereof without departing from the essential scope of the invention. In addition, many modifications may be made to adapt a particular situation or material to the teachings of the invention without departing from the essential scope thereof. Therefore, it is intended that the invention not be limited to the particular embodiments, but that the invention shall include all embodiments falling within the scope of the claims.

What is claimed is:

1. An oral hygiene device comprising:
a body having a first end, a second end, a handle extending between the first and second ends, a first side and a second side;
a brush positioned on the first side adjacent to the first end;
a flosser positioned adjacent to the second end;
a pick positioned adjacent to the handle; and
a scraper positioned on the second side adjacent to the first end.

2. The oral hygiene device of claim 1, wherein the brush has a generally circular configuration.

3. The oral hygiene device of claim 1, wherein the first end has a generally circular configuration and the brush includes a plurality of bristles arranged in the generally circular configuration.

4. The oral hygiene device of claim 1, wherein the first end includes an opening extending between the first and second sides positioned adjacent to the brush.

5. The oral hygiene device of claim 1, wherein the flosser includes a first support member and a second support member adapted to support dental floss.

6. The oral hygiene device of claim 5, wherein the second support member is longer than the first support member.

7. The oral hygiene device of claim 1, wherein the pick is movable with respect to the handle.

8. The oral hygiene device of claim 1, wherein the handle includes a hinge to allow the second end to move from a first position to a second position so that the pick extends from the first end for use.

9. The oral hygiene device of claim 1, wherein the pick is joined to the handle by a frangible attachment member.

10. The oral hygiene device of claim 1, wherein the scraper has a generally semi-circular configuration.

11. The oral hygiene device of claim 1, wherein the handle includes a first side grip.

12. The oral hygiene device of claim 1, wherein the handle includes a second side grip.
